(19) United States
(12) Patent Application Publication
(10) Pub. No.: US 2026/0063066 A1
(43) Pub. Date: Mar. 5, 2026

(54) SENSOR AND EVALUATION DEVICE, CONTROL ENVIRONMENT AND METHOD FOR DETECTING MISFIRING, AND INTERNAL COMBUSTION ENGINE HAVING THE SENSOR AND EVALUATION DEVICE AND/OR CONTROL ENVIRONMENT

(71) Applicant: Rolls-Royce Solutions GmbH, Friedrichshafen (DE)

(72) Inventors: Aron Toth, Friedrichshafen (DE); Simon Rau, Bad Saulgau (DE); Jörg Remele, Hagnau (DE); Daniel Sobczyk, Kirchheim (DE)

(73) Assignee: Rolls-Royce Solutions GmbH, Friedrichshafen (DE)

(21) Appl. No.: 19/385,655

(22) Filed: Nov. 11, 2025

Related U.S. Application Data
(63) Continuation of application No. PCT/EP2024/062762, filed on May 8, 2024.

(30) Foreign Application Priority Data
May 11, 2023 (DE) 10 2023 112 519.2
May 8, 2024 (WO) PCT/EP2024/062762

(51) Int. Cl. F02B 77/08; G01M 15/11

(52) U.S. Cl. CPC F02B 77/085; G01M 15/11

(57) ABSTRACT

A sensor and evaluation device configured for detecting a misfire in an internal combustion engine, the sensor and evaluation device including: a control sensor system, which includes an acceleration sensor configured for acquiring a sound measurement signal at a cylinder and for providing a knock signal assigned to the sound measurement signal; and a module configured for at least one of acquiring and evaluating the knock signal, wherein the sensor and evaluation device is configured such that: an evaluation-relevant operating cycle angle range is assigned to an operating cycle range after an exhaust valve is opened; the sound measurement signal at the cylinder is detected by the acceleration sensor at least for the evaluation-relevant operating cycle angle range, and the knock signal assigned to the sound measurement signal for the evaluation-relevant operating cycle angle range is fed to the module in an evaluable manner.

### CROSS REFERENCE TO RELATED APPLICATIONS

This is a continuation of PCT application no. PCT/EP2024/062762, entitled “SENSOR AND EVALUATION APPARATUS, CONTROL ENVIRONMENT AND METHOD FOR DETECTING MISFIRING, AND COMBUSTION ENGINE HAVING THE SENSOR AND EVALUATION APPARATUS AND/OR CONTROL ENVIRONMENT”, filed May 8, 2024, which is incorporated herein by reference. PCT application no. PCT/EP2024/062762 claims priority to German patent application no. 10 2023 112 519.2, filed May 11, 2023, which is incorporated herein by reference.

### BACKGROUND OF THE INVENTION

### 1. Field of the Invention

The present invention relates to a sensor and evaluation device.

### 2. Description of the Related Art

When operating an internal combustion engine, provision is made that an operating medium in the cylinder is viable for ignition and combustion by driving a piston in the cylinder, which cycles the operating cycle for intake, compression, working, and expulsion of the operating medium via its piston stroke. Intake is thereby linked to the opening of the intake valve, and expulsion is linked to the opening of the exhaust valve.

A control sensor system includes an acceleration sensor, in particular a knock sensor, for detecting a sound measurement signal at the cylinder, wherein the acceleration sensor provides a knock signal that is assigned to the sound measurement signal and wherein a signal acquisition and/or evaluation module is configured to detect and evaluate the knock signal. The sensor and evaluation device is designed to detect misfiring in an internal combustion engine.

When operating an internal combustion engine involving the ignition and combustion of operating medium, the adjustment and monitoring of the ignition, in particular an optimized ignition timing, is absolutely crucial for the operation of the internal combustion engine. This applies not only to the operation of the internal combustion engine as such, but also to servicing, ongoing monitoring, and maintenance of the internal combustion engine throughout its service life.

A method is known for example from DE 10 2010 062 198 B4 for operating an Otto gas engine by adjusting the ignition timing. Aspects such as the composition of the combustion gas mixture, the temperature and pressure conditions, and the air supply settings play a role herein.

Regarding the operation of an internal combustion engine, for example in the embodiment of a gas engine, a control and regulating device for controlling and regulating the gas engine depending on changing boundary conditions, which includes a pilot control device with sensors for measuring the boundary conditions, is basically known from DE 198 08 829 B4. This and other similar methods show that it is generally optional to keep the engine operating point within the limits of an operating range that is defined on the one hand by the knock limit or the pollutant emission limits that are to be adhered to and on the other hand by the lean-burn limit. In this case, the gas engine should be operationally reliable, that is, free from knocking and misfiring, with the maximum achievable power and the best possible efficiency while complying with pollutant limits as far as possible, even under rapidly changing conditions.

Over-critical operation of the engine at the knock limit or misfiring limit should be avoided. For this purpose, a pilot control device is superordinate to a knock monitoring device, which has at least one sensor that records the combustion chamber temperature and/or structure-borne sound signals and/or ignition pressure evaluations. When the operating point has reached the minimum distance from the knock limit of the gas engine, the engine power should be adjusted or the internal combustion engine should be stopped, wherein the distance to the knock limit can be calculated based on the input signals received from the sensors.

An example of a knock sensor is known from DE 10 2015 200 216 A1 as a vibration sensor for detecting vibrations from a component that causes vibrations. An element designed as a knock sensor or as a different element is attached directly to the fastening element.

An internal combustion engine is generally understood herein to mean any type of internal combustion engine using an operating medium that is ignited and burned. This can, of course, also be a self-igniting internal combustion engine, i.e. with a diesel engine. In particular, an internal combustion engine is an internal combustion engine, such as an Otto engine, in particular a gas engine, or a diesel engine. An internal combustion engine, hereinafter also simply referred to as “engine,” can thus accordingly be actively ignited or self-igniting; thus, it can be designed to ignite and combust the operating medium; optionally, however, it can optionally have an ignition device and/or an injection device.

The above-mentioned DE 198 08 829 B4 indicates that, analogously, misfiring detection only responds when misfiring actually occurs, although this condition is already associated with a significant loss of efficiency.

DE 195 36 110 B4 proposes enabling cylinder-specific injection start and combustion start detection using only one structure-borne sound sensor mounted to the outside of the engine. This results in considerable cost savings and functional advantages over previously known systems. For this purpose, an output signal from a structure-borne sound sensor or knock sensor is fed to filter ways, and based on the output signal of a first filter way a variable characterizing the start of fuel injection is determined, and based on the output signal of a second filter way a variable characterizing the start of combustion is determined. This should make it possible to detect the end of the injection process and a primary injection. Overall, the start of combustion should be detected from low-frequency components of the signal. For this purpose, signals can be displayed temporally over a combustion process. During the rise in the pressure progression in the cylinder, a first movement of the needle movement sensor occurs with a low intensity. After a short delay, the second rise in the needle movement sensor signal occurs. The first rise can be attributed to a pre-injection. Simultaneously with the occurrence of the first signal, the amplitude of the structure-borne noise sensors increases. With the second rise in the needle motion sensor, shortly before maximum cylinder pressure, the amplitude of the structure-borne noise sensor increases sharply. If it is indicated that an injection has occurred after the start of injection and, at the same time, no combustion has occurred after the start of combustion, it is recognized that a combustion misfire (respectively misfiring) is present.

However, such a signal for diagnosis and the evaluation method used to control the internal combustion engine are comparatively unreliable, because they still rely on other signal presets. On the other hand, the detection of misfiring in the engine management system is essential, as several consecutive operating cycles without ignition can lead to an explosion in the exhaust tract. Sensors installed in the exhaust tract, as well as the exhaust system itself, can thereby be damaged. Moreover, increased hydrocarbon emissions occur with misfiring, which is undesirable in modern internal combustion engines with regard to upper limits for limiting hydrocarbon emissions.

The detection of misfires, for example by way of cylinder pressure sensors or individual exhaust gas temperature sensors, is also known, including the evaluation of suitable signals. However, the aforementioned approaches require comparatively expensive sensors and an additional, expensive measuring system on the engine. Moreover, comparatively complex implementation techniques are required, as well as a separate bore per cylinder for sensor integration.

It is therefore desirable to detect a misfiring in an improved manner.

What is needed in the art is a device and a method by way of which a predetermination is made or a method for detecting misfires is provided by way of an acceleration sensor, in particular a knock sensor, optionally by way of only evaluating a signal from an acceleration sensor, in particular a knock sensor, by considering the aforementioned circumstances.

What is needed in the art is a sensor and evaluation device to detect a misfire in an internal combustion engine, as well as an internal combustion engine and sensor and evaluation device, which is optionally designed to detect and evaluate a knock signal and, based thereupon, in particular based solely thereupon, to detect misfiring. This should be comparatively simple and concurrently reliable with regard to the signal basis and evaluation.

### SUMMARY OF THE INVENTION

The invention relates to a sensor and evaluation device. The sensor and evaluation device is designed to detect a misfire in an internal combustion engine. The invention also relates to a control environment of an internal combustion engine with a control device, optionally an engine control unit (ECU), including the sensor and evaluation device. The control device can have a signal acquisition and/or evaluation module, and the control sensor system includes an acceleration sensor, in particular a knock sensor, which is signal-connected to the signal acquisition and/or evaluation module. The invention also relates to an internal combustion engine, in particular a gasoline or diesel engine, having a control environment, and the invention relates to a method for detecting misfiring in an internal combustion engine.

Accordingly, the invention relates to a sensor and evaluation device, designed to detect a misfire in an internal combustion engine, in particular a combustion engine, including:
a control sensor system which includes an acceleration sensor, in particular a knock sensor to detect a sound measurement signal at the cylinder, wherein the acceleration sensor provides a knock signal assigned to the sound measurement signal;
a signal acquisition and/or evaluation module designed to acquire and evaluate the knock signal.

According to the invention, it is provided that:
an evaluation-relevant operating cycle angle range is assigned to an operating cycle range after the exhaust valve is opened; and
the sound measurement signal at the cylinder can be detected by the acceleration sensor, in particular the knock sensor, at least for the evaluation-relevant operating cycle angle range; and
the knock signal assigned to the sound measurement signal for the evaluation-relevant operating cycle angle range can be fed to the signal acquisition and/or evaluation module in an evaluable manner.

The invention is based on detecting misfiring using an acceleration sensor, in particular a knock sensor. It is however desirable to design such misfiring detection in a simple yet reliable manner. In this regard, a signaling specification should be reliable and easily recognizable by an acceleration sensor, in particular a knock sensor.

Misfiring can also be detected with cylinder pressure sensors or individual exhaust gas temperature sensors. However, the advantage of an acceleration sensor—especially a knock sensor—is, that it is significantly cheaper and more durable than the aforementioned sensors. In addition, an individual exhaust gas temperature sensor cannot detect a single misfire due to its inertia; an acceleration sensor, particularly a knock sensor, on the other hand, can. Also, an acceleration sensor, in particular a knock sensor, can also be used on an internal combustion engine, particularly a gas engine, to control knocking on a cylinder.

The invention has also recognized that, based on a knock signal provided by the acceleration sensor, in particular the knock sensor, an operating cycle angle range relevant for evaluation can be assigned to an operating cycle range after the exhaust valve has opened. The advantageous selection of the evaluation-relevant operating cycle angle range according to the concept of the invention is based on the recognition that the signal is particularly dominant there. The invention has recognized that the sound measurement signal at the cylinder from the acceleration sensor, in particular the knock sensor, is particularly advantageously detectable at least for the evaluation-relevant operating cycle angle range, and also that the knock signal assigned to the sound measurement signal can be fed to the signal acquisition and/or evaluation module in an analyzable manner for the evaluation-relevant operating cycle angle range.

Thus, no additional sensor costs arise due to the existing acceleration sensor, which can be designed, in particular, as a knock sensor. There is also no need for complex indexing holes in the engine, as required by the cylinder pressure sensors, to be provided in the combustion chamber. The knock signal provided by the acceleration sensor, in particular the knock sensor, is evaluated in a manner according to the invention for the evaluation-relevant operating cycle angle range selected in an inventive manner, in particular a predetermined and/or variable, but firmly specified, evaluation-relevant operating angle range.

The acceleration sensor can be designed in particular, as a knock sensor, which is also typically required and used on an internal combustion engine for knock detection. Strictly speaking, in addition or alternatively to an acceleration sensor, another sensor unit suitable and designed for detecting a knock signal can be provided on an internal combustion engine, which is designed to specify a knock signal by measuring and/or calculating measured values—which may include acceleration values, but do not necessarily have to include them. An acceleration sensor has proven advantageous, in particular for detecting a structure-borne sound signal, in particular, a structure-borne sound detectable as a vibration on the engine block, in particular the cylinder, optionally the cylinder head.

An acceleration sensor can be broadly defined and can, for example, also be a vibration sensor or a vibration pick-up, or another sensor designed to detect a vibration amplitude in the broadest sense, especially including structure-borne noise or sound. In addition, or as an alternative to an acceleration sensor, a sensor unit can also be provided on an internal combustion engine, which is designed to indicate a knock signal by measuring and/or calculating from other measured values, including, for example, acoustic measured values.

The physical sound measurement signal is detected by the acceleration sensor, in particular the knock sensor; the “electronic” signal or similar signal generated on the basis of this detection in the acceleration sensor, in particular in the knock sensor, is referred to as the knock signal, which is assigned to the physical sound measurement signal.

In the context of this application, a knock signal is understood to be any measurement signal that clearly indicates irregular ignition behavior, in particular, indicates in a recognizable manner a misfire and/or no misfire (insofar as normal ignition operation) in other words - thus indicates an operating cycle that exhibits a misfire and/or no misfire (insofar as normal ignition operation).

An inventive acceleration sensor includes in particular also a sensor unit which is designed as a so-called knock sensor, in particular like some of the type described above.

In a second aspect, the present invention also provides a device in a control environment of an internal combustion engine with a control device, optionally an engine control unit (ECU), with the sensor and evaluation device according to the concept of the invention.

The control device includes the signal acquisition and/or evaluation module and the control sensor system including the acceleration sensor, in particular the knock sensor, which is signal-connected to the signal acquisition and/or evaluation module. The control environment also includes:
an encoder unit to detect the operating cycle angle, in particular by way of the crank angle, of a cylinder of the internal combustion engine, in particular a measuring wheel on the internal combustion engine for detecting an operating cycle angle of a cylinder of the internal combustion engine, in particular a measuring wheel in the form of an encoder gear, wherein the encoder unit is signal-connected to the signal acquisition and/or evaluation module.

Regarding the device, the present invention also provides in a third aspect an internal combustion engine, in particular an Otto or diesel engine, having a control environment according to the concept of the invention and/or with a control device, optionally an engine control unit (ECU), and/or with the sensor and evaluation device according to the concept of the invention to detect misfiring.

The internal combustion engine has a number of cylinders, and a cylinder has one or more intake and exhaust valves, and also an optional ignition unit and/or injection unit. The internal combustion engine is designed so that:
an operating medium in the cylinder is viable for ignition and combustion by driving a piston in the cylinder, which cycles the operating cycle for intake, compression, working, and expulsion of the operating medium over its piston stroke, wherein intake is associated with opening of the intake valve and expulsion is associated with opening of the exhaust valve; and
the intake and exhaust valves can be operated by way of a valve train via an operating cycle angle of the operating cycle for the operating medium.

An internal combustion engine is understood to be a combustion engine - hereinafter also referred to as “engine” for short - in the true sense of the word. This applies in particular to gasoline or diesel engines. A combustion engine typically includes a corresponding engine block with a number of cylinders.

A cylinder has one or a number of intake and exhaust valves, and optionally also an ignition unit and/or injection unit. The intake and exhaust valves are operated by a valve train over an operating cycle angle for the operating fluid. The valve train typically includes a camshaft driven by the crankshaft and intake and exhaust valves actuated by a pushrod and rocker arm.

With regard to the method, the present invention provides a method for detecting misfiring in an internal combustion engine, including a control device and a control sensor system which is signal-connected to the control device, wherein:
the control sensor system includes an acceleration sensor, in particular a knock sensor, for detecting a sound measurement signal at the cylinder, wherein the acceleration sensor provides a knock signal assigned to the sound measurement signal;
has a signal acquisition and/or evaluation module which is designed to detect and evaluate a knock signal.

According to the invention, the method is characterized by the following steps in that:
an evaluation-relevant operating cycle angle range is assigned to an operating cycle range after the exhaust valve is opened;
the sound measurement signal at the cylinder is detected by the knock sensor at least for the evaluation-relevant operating cycle angle range; and
the knock signal assigned to the sound measurement signal for the evaluation-relevant operating cycle angle range is fed to the signal acquisition and/or evaluation module in an evaluable form.

In the method, it is provided in particular that an operating medium in the cylinder is viable for ignition and combustion by driving a piston in the cylinder, which cycles the operating cycle for intake, compression, working and expulsion of the operating medium via its piston stroke, wherein:
intake is associated with opening of the intake valve and expulsion is associated with opening of the exhaust valve; and
the acceleration sensor sensorically detects the sound measurement signal at the cylinder associated with the expulsion of the operating medium, in particular after the exhaust valve has opened.

According to the concept of the invention, misfiring is detected in an advantageous and surprisingly simple and reliable manner compared to the current state of the art with the assistance of an acceleration sensor, in particular a knock sensor.

An optional further development of the sensor and evaluation device provides that the sound measurement signal at the cylinder is assigned entirely or partially to the exhaust cycle as an evaluation-relevant operating cycle angle range.

An optional further development of the sensor and evaluation device provides that the sound measurement signal includes a structure-borne sound measurement signal at the cylinder, in particular the cylinder head, and/or an acoustic sound measurement signal in the surrounding of the cylinder, in particular the cylinder head. A sound measurement signal with a particularly good signal/background and/or low noise level can be measured at the cylinder head.

The acceleration sensor is optionally a piezo sensor, especially in the embodiment of a MEMS (micro-electro-mechanical system) sensor. This type of implementation facilitates a comparatively space-saving sensor design that can be protected from the environment.

The evaluation-relevant operating cycle angle range is advantageously predefined. In particular, it can be specified as variable but fixed, for example, depending on the engine. The sound measurement signal at the cylinder is thus assigned to the exhaust cycle in whole or in part as the evaluation-relevant operating cycle angle range.

An optional further development of the sensor and evaluation device provides that the signal acquisition and/or evaluation module is designed for detection and/or integration of the knock signal for the evaluation-relevant operating cycle angle range. This is advantageous for the improvement of the “signal-to-noise” ratio. The advantageous selection of the evaluation-relevant operating cycle angle range according to the concept of the invention is based on the realization that the signal is especially dominant there. The aforementioned integration or other additional measures are beneficial to signal amplification and/or signal sharpening.

An optional further development of the sensor and evaluation device provides that the signal acquisition and/or evaluation module is designed for comparison of the knock signal that is integrated via the evaluation-relevant operating cycle angle range, with a threshold value.

An optional further development of the sensor and evaluation device provides that the signal acquisition and/or evaluation module is designed to derive a measurement value from the detected and/or integrated knock signal via the evaluation-relevant operating cycle angle range, which is relevant for detecting misfiring, in particular misfire cycles.

An optional further development of the sensor and evaluation device provides that the signal acquisition and/or evaluation module is designed to compare the measured value with the threshold value, wherein misfiring, in particular a misfiring cycle, is detected when the measured value is below the threshold value. In other words, an unignited operating medium flows out of the cylinder with a lower sound measurement signal level, resulting in a correspondingly lower knock signal level. In particular, an integrated knock signal is then correspondingly lower or below the threshold value.

It is advantageously provided that the detection of individual misfires forms the basis for further diagnostic functions, for example, in spark plug monitoring. This allows the remaining service life of the spark plug to be estimated.

An optional further development of the sensor and evaluation device provides that the encoder unit includes an encoder gear wheel for detecting the operating cycle angle.

An optional further development of the sensor and evaluation device provides that the acceleration sensor, in particular the knock sensor, is arranged on the cylinder head.

The acceleration sensor, in particular the knock sensor, can be attached advantageously to the cylinder head by way of a cylinder head bolt or cylinder head cover. In other words, the method and device according to the concept of the invention benefit from this further development with an acceleration sensor, in particular a knock sensor, mounted as closely as possible to the combustion chamber of the cylinder, or specifically close to the exhaust valve.

As can be seen, there is comparatively less noise interference at the cylinder head. Here a cylinder head cover is considered, particularly for attaching the acceleration sensor so that the acceleration sensor can detect the sound measurement signal associated with the expulsion of the operating medium, especially after the exhaust valve has been opened. The cover covers the valve tappets and rocker arms in particular. The gas flow noise during the outflow of the operating medium, particularly after the exhaust valve opens, and the associated sound measurement signal at the cylinder, can be particularly advantageously detected there - in or outside the cover.

An optional further development of the sensor and evaluation device provides that the sound measurement signal is a structure-borne sound signal.

Overall, it has proven effective that no additional sensors or measuring systems, including a wiring harness, are required on the internal combustion engine for misfiring detection. This makes the entire system more cost-effective and robust, as fewer sensors and fewer controllers are used on the internal combustion engine.

Acceleration sensors, especially knock sensors, are significantly cheaper and significantly more robust and durable compared to expensive cylinder pressure and individual exhaust gas temperature sensors. The cylinder pressure sensor as well as the individual exhaust gas temperature sensor require an additional bore in the engine for each cylinder.

A sensor device includes the acceleration sensor, in particular a knock sensor, and a cable connection with an interface.

The interface can be connected with the control device and/or a data BUS, for example, a vehicle BUS, for example a CAN BUS. Such a device can record a sound measurement signal by way of the acceleration sensor, in particular the knock sensor, and can thus perform knock detection on the internal combustion engine within the framework of the detection and evaluation device. The knock signal corresponding to the sound measurement signal can be transmitted to the control device by way of such a device. Optionally, an already existing device can also evaluate the knock signals for possible misfiring.

Since, for example, the aforementioned device for knock detection is already installed on the internal combustion engine, it can also be used for misfiring detection. Individual misfiring can be detected by way of knock-and cylinder pressure sensors, but not by way of individual exhaust gas temperature sensors due to the inertia of individual exhaust gas temperature sensors.

Embodiments of the invention are described below with reference to the drawings, compared to the current state of the art which, in part, is also shown. These embodiments are not intended to be shown to scale; rather, where useful for explanation, the drawings are presented in schematic and/or slightly distorted form. With regard to additions to the teachings immediately apparent from the drawings, reference is made to the relevant prior art. It should be noted that diverse modifications and changes can be made to the form and detail of an embodiment without deviating from the general idea of the invention. The characteristics of the invention disclosed in the description, the drawings, and the claims can be essential to the further development of the invention both individually and in any combination. Moreover, any combinations of at least two of the characteristics disclosed in the description, the drawings, and/or the claims fall within the scope of the invention. The general idea of the invention is not limited to the exact form or detail of the optional embodiment shown and described below or limited to an object that would be limited compared to the object claimed in the claims. For specified design ranges, values within the stated limits are also intended to be disclosed as limit values and can be used and claimed randomly.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A is a schematic representation of a cylinder with piston and valve train according to the concept of the invention, a symbolically represented encoder unit for detecting an operating cycle angle, an acceleration sensor, in particular a knock sensor, for detecting a sound measurement signal at the cylinder, and a control device with a signal acquisition and/or evaluation module according to an optional embodiment of the invention;

FIG. 1B is an exemplary representation of the operating cycle of a piston in the cylinder, which is timed over the piston stroke for intake, compression, working, and expulsion of the operating medium, wherein the valve lift of an exhaust valve (left) and an intake valve (right) on the cylinder is shown over the crank angle for two revolutions according to one operating cycle;

FIG. 2 is an exemplary representation of a knock signal at a cylinder, wherein a first knock signal for an operating cycle without combustion (ASoV) and a second knock signal for an operating cycle with combustion (ASmV) are plotted over the operating cycle angle as shown in FIG. 1B for an acceleration sensor, in particular a knock sensor, for detecting a knock signal, especially for the exhaust valve;

FIG. 3A shows cylinder pressure signals for a number of operating cycles, wherein a cylinder pressure signal is respectively calculated over a respective operating cycle angle range, wherein each of the values shown represents the indicated average effective pressure over the high pressure phase (IMEPH) at a respective operating cycle as a value, that is, one cylinder pressure value per operating cycle for the number of operating cycles;

FIG. 3B shows knock signals calculated for the same number of operating cycles as in FIG. 3A, each value shown representing an integrated knock signal that is assigned to the evaluation-relevant operating cycle angle range according to the concept of the invention after the opening of the exhaust valve, in particular to the evaluation-relevant operating cycle angle range marked “X”in FIG. 1B and FIG. 2;

FIG. 4 is a schematic representation of the sensor and evaluation device for an internal combustion engine shown in FIG. 1A with the components according to the concept of the invention and with a schematically illustrated functionality of a signal acquisition and/or evaluation module according to an optional embodiment; and

FIG. 5 is an optional embodiment of a method according to the concept of the invention for detecting a misfire in an internal combustion engine of a combustion engine with a sensor and evaluation unit according to one of the optional design examples presented above.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

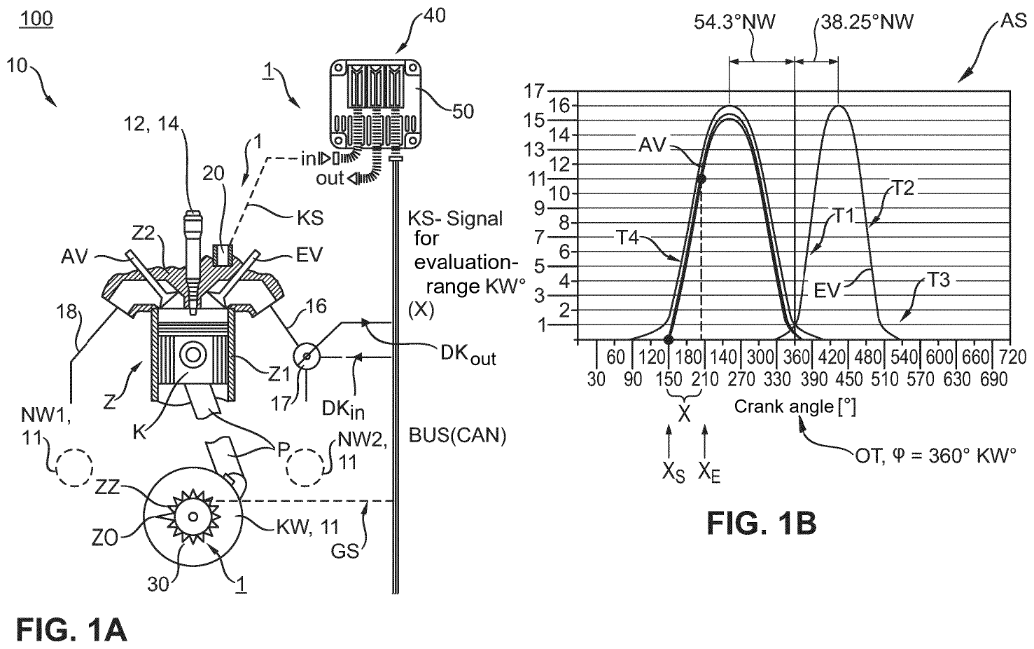

FIG. 1A shows an internal combustion engine with control environment 100. In an optional embodiment, this includes a symbolically represented internal combustion engine, referred to below as combustion engine 10 (engine 10 for short).

Engine 10 is equipped with a detection and evaluation device 1 which is designed to detect misfiring in an engine 10. In the sense of a combustion engine 10, the internal combustion engine is referred to below also as engine 10.

Of engine 10, a single cylinder Z with its piston K is shown here by way of example, which is operatively connected via a connecting rod P in a manner known to a crankshaft KW of engine 10 for transmitting the drive power to the piston to crankshaft KW, that is for transmitting the drive power from the piston to/onto the crankshaft. Accordingly, FIG. 1A schematically shows the engine block of engine 10 with cylinder Z, crankshaft KW, and camshafts NW1, NW2 of engine 10.

Crankshaft KW and camshafts NW1, NW—in this example shown schematically at the bottom—are part of a valve train 11, shown here as an example and merely symbolically. Valve train 11 is designed overall to actuate intake and exhaust valves EV, AV of engine 10, which are also represented symbolically here. The corresponding valve lift for an intake valve EV or exhaust valve AV, as an exemplary expression of the operating cycle, is shown in FIG. 1B as a valve lift over a crank angle φ.

The operating cycle is to be understood in a conventional manner as a sequential cycle for intake T1, compression T2, working T3 and exhaust T4 of the operating medium over its piston stroke. The progression of the valve lift is therefore coordinated with the piston stroke. An example valve lift is shown in FIG. 1B. Specifically, an operating medium in cylinder Z is converted for ignition and combustion by driving piston K in cylinder Z, which cycles the operating cycle for intake T1, compression T2, working T3 and exhaust T4 of the operating medium via its piston stroke, wherein the intake is associated with an opening of intake valve EV, and the expulsion is associated with an opening of exhaust valve AV.

According to the concept of the invention, it is provided that an acceleration sensor, in particular knock sensor 20, is designed to sensorily detect a sound measurement signal SM at cylinder Z, which is associated with the expulsion of the operating medium, in particular between start X_{S} of the expulsion of the operating medium, in particular after the opening of the exhaust valve, and end X_{E} of the expulsion of the operating medium, in particular before the closing of exhaust valve AV. This is explained in further detail below.

It is to be understood in particular, that in the evaluation-relevant operating cycle angle range X of crank angle φ, represented and highlighted here with X—between start X_{S} and end X_{E} in units of crank angle φ—after opening of exhaust valve AV, that is in exhaust cycle T4, a sound measurement signal can be detected at cylinder Z by knock sensor 20 at least for this evaluation-relevant operating cycle angle range X. The sound measurement signal is therefore the sound measurement signal SM associated with the expulsion of the operating medium, detectable at cylinder Z between start X_{S} (after the expulsion of the operating medium has begun, in particular after the opening of the exhaust valve) and end X_{E} (prior to the end of the expulsion of the operating medium, in particular before the closing of the exhaust valve).

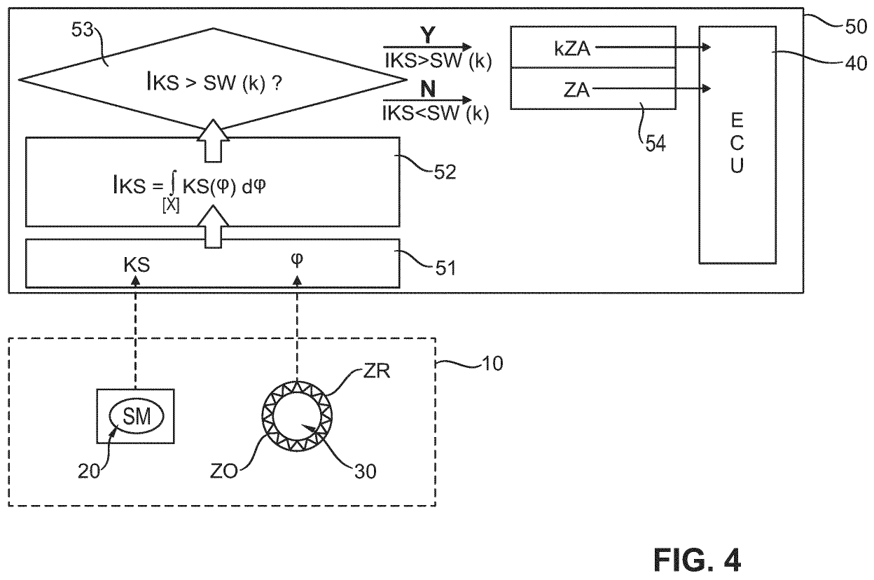

FIG. 1A again shows detection and evaluation device 1, the acceleration sensor, in particular knock sensor 20, encoder unit 30, and control device 40, optionally engine control unit (ECU), with a signal acquisition and/or evaluation module 50, which is to be explained in further detail with reference to FIG. 4, which is only symbolically indicated here.

The internal combustion engine symbolically represented here, hereinafter also referred to as engine 10, has an optional but nevertheless optional ignition unit and/or injection unit 12, 14, which for simplicity's sake is shown here as a symbolic injector for reference purposes. However, the ignition unit with spark plug and the like understandably looks different and is also arranged differently in the cylinder. Cylinder Z itself has a cylinder sleeve Z1 and a cylinder head Z2, the details of which are known in principle. Cylinder sleeve Z1 serves to guide piston K in its up and down movement during the operating cycle. Cylinder head Z2 supports an injection unit 12 with an injector symbolically represented here. Similarly, a spark plug or similar ignition element of an ignition device 14 can be provided in cylinder head Z2 via a suitable opening in the cylinder interior above piston K.

Cylinder head Z2 also has suitable manifold openings to accommodate one or more intake valves EV to the cylinder chamber and, correspondingly, one or more arrangements of exhaust valves AV, also to the cylinder chamber of cylinder Z with piston K.

Furthermore, an intake air duct 16 and an exhaust gas duct 18 are connected to cylinder head Z2 via a manifold feed. When intake and exhaust valves AV, EV are activated via valve train 11 in the manner described above, intake air enters the cylinder interior via intake air duct 16, in other words, above piston K, inside cylinder sleeve Z1 via intake valve EV. The intake air can be controlled via a throttle valve 17. Throttle valve 17 can be signal-connected to the control device 40 via a BUS (i.e. a CAN BUS) with an appropriate signal connection; this is intended to regulate the intake air and thus to control an optimized ratio of operating medium, such as gas, on the one hand, and intake air at the correct lambda ratio, on the other. The signal connection transmits corresponding throttle valve input signals DKin and output signals DKout.

The operating medium is supplied via injector 12 shortly before a top dead center (TDC) in operating cycle AS, which is symbolically represented in FIG. 1B as explained.

After intake T1, intake valve EV closes. This is followed by compression T2 and operating T3 with the intake and exhaust valves EV and AV closed.

For exhaust T4, exhaust valve AV opens. During this exhaust cycle T4, intake valve EV is closed and exhaust valve AV is open.

The entire cycle of exhaust T4 is shown in the left-hand section of FIG. 1B as the opening stroke of the valve lift for exhaust valve AV, over the angular range, that is the crankshaft angle, as shown there, in this case at least between X_{S}=140° and X_{E}=360° of the T4 exhaust cycle. In the present example, it can also be at least between X_{S}=111° and X_{E}=380° for exhaust cycle T4.

The evaluation-relevant operating angle range X can be variable but fixed, individually for each cylinder; it is thus predetermined. The measurement value of the crankshaft angle can be selected differently.

The exhaust gases from the cylinder chamber within cylinder sleeve Z1 above piston K can escape from cylinder Z via exhaust line 18 when exhaust valve AV is open. Between start X_{S} of the expulsion of the operating medium, in particular after opening of the exhaust valve, and end X_{E} of the expulsion of the operating medium, in particular before the closing of the exhaust valve, a sound measurement signal is recorded at the cylinder.

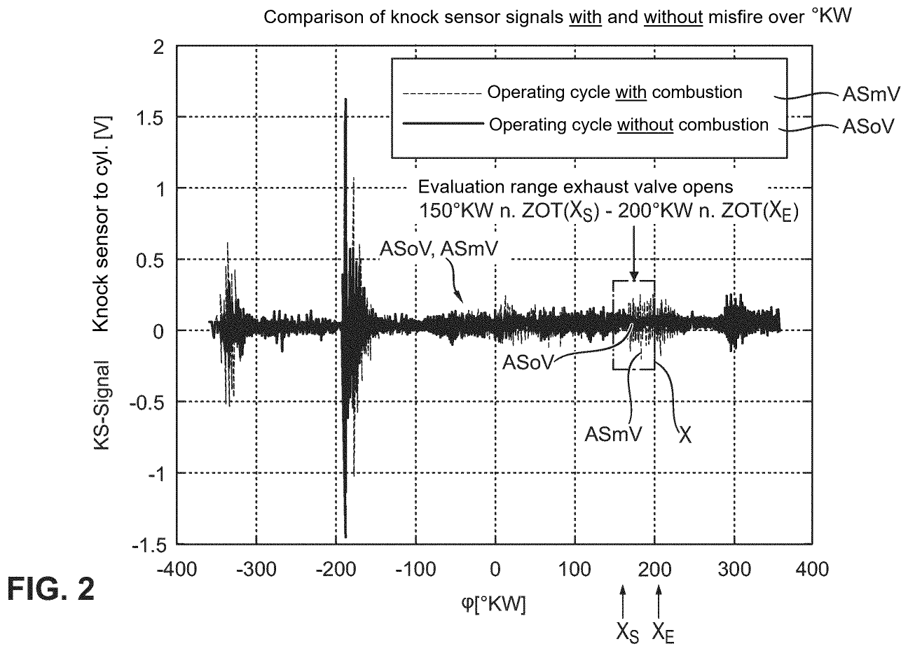

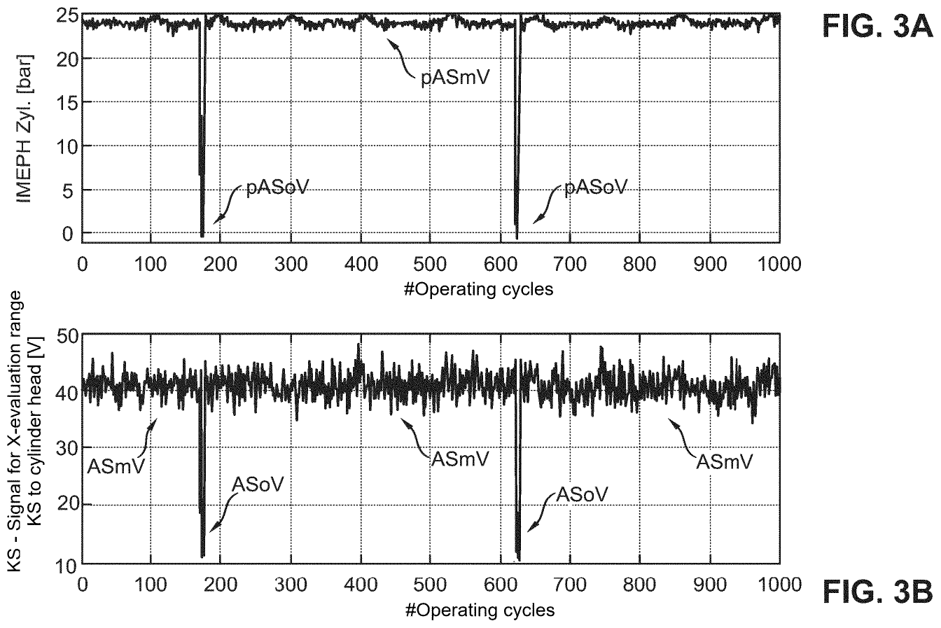

The sound measurement signals occurring particularly in the evaluation-relevant operating cycle angle range X—between start X_{S} and end X_{E} of the expulsion - are explained in detail in FIG. 2, and the evaluation thereof on the basis of FIG. 3A, FIG. 3B.

The physical sound measurement signal is detected by knock sensor 20; the “electronic” signal or similar signal generated in knock sensor 20 as a result of its detection is referred to as knock signal KS, which is assigned to the physical sound measurement signal.

It should be noted here that the signals relevant to sensor and evaluation device 1, such as encoder signal GS of encoder unit 30 and knock signal KS of the acceleration sensor, in particular knock sensor 20, are detected in signal acquisition and/or evaluation module 50. Signal acquisition and/or evaluation module 50 may, but need not, be designed as part of control device 40, optionally engine control unit (ECU).

Knock signal KS can generally be detected by sensors which are designed and arranged to detect knock signal KS or a similar signal. Knock signal KS or similar signal can be transmitted directly or analogously to control device 40 as a detection and evaluation device. For example, as shown in FIG. 1A, a knock signal KS or similar signal can be transmitted directly or analogously to an input “IN” of control device 40. An output “OUT” of control device 40 can be signal-connected to the other peripherals of engine 10 or respectively internal combustion engine 100. This signal transmission has proven to be relatively easy to implement and retrofit.

In addition, or alternatively (not shown here), knock signal KS or similar signal can also be digitized and transmitted via the BUS; in this way, knock signal KS or similar signal can also be transmitted to control device 40 as a sensor and evaluation device. Control device 40 is also signal-connected to other inputs and the BUS and is thus signal-connected to the other periphery of engine 10 or the internal combustion engine with control environment 100 for the exchange of incoming and outgoing signals.

In this case, encoder unit 30 is mounted at a fixed angle as gear ZR of crankshaft KW and can mark the top dead center at crankshaft angle φ=360° via a tooth Z0, for example, as additionally shown in FIG. 1B during the interaction of intake valve EV and exhaust valve AV.

As shown in more detail in FIG. 4, encoder unit 30 can thus be designed as part of engine 10, for example, in the form of a suitable gear ZR with a pointer ZO, to detect an operating cycle angle φ. Accordingly, a corresponding knock signal KS is assigned to the operating cycle angle in an operating cycle angle for a sound measurement signal SM detected by the acceleration sensor, in particular knock sensor 20 in the present case.

Knock signal KS is detected by engine control unit 40 (commonly referred to as ECU) primarily in the operating cycle angle range designated X, which is relevant for evaluation; however, another detection and/or control unit may also be provided in engine 10 to detect knock signal KS.

Evaluation-relevant operating cycle angle range X can be variable but fixed, individually for a cylinder; thus, it is predetermined. The crankshaft angle measurement for this can be chosen differently.

Evaluation-relevant operating cycle angle range X is specifically and especially optionally an operating cycle angle φ between X_{S}=150° and X_{E}=210° in the operating cycle. The sensor device including the acceleration sensor, in particular knock sensor 20, thus detects the sound signal at cylinder Z, optionally at cylinder head ZK, and transmits a knock signal KS that is assigned to the sound signal in this evaluation-relevant, predetermined and, if necessary, variably adjustable operating cycle angle range X to signal acquisition and/or evaluation module 50. The operating cycle angle range can, in contrast to the operating cycle angle range X shown as an example, also include a larger angular range or a smaller angular range as part of exhaust cycle T4. However, evaluation-relevant operating cycle angle range X begins with or at least shortly after the expulsion of the operating medium, in particular with the start (X_{S}) of the expulsion of the operating medium, in particular after the opening of the exhaust valve. The evaluation-relevant operating cycle angle range X can extend up to the uppermost lifting point of exhaust valve AV. However, it particularly encompasses a region with a comparatively large opening width of exhaust valve AV, that is, where a relatively large flow of operating fluid is present. As explained by way of FIG. 2, it can be seen that, according to the concept of the invention, sound measurement signal SM and, accordingly, knock signal KS are comparatively large there.

The operating cycle angle, respectively measured over crank angle φ is thus assigned to a knock sensor signal KS and is transmitted to signal acquisition and/or evaluation module 50. Signal acquisition and/or evaluation module 50 therefore has an acquisition interface 51 in which the knock sensor signal is made available as a function of the operating cycle angle or respectively crank angle φ for further processing in signal acquisition and/or evaluation module 50.

Computing module 52 of signal acquisition and/or evaluation module 50 is designed to perform an integral operation for the function of knock sensor signal KS over the operating cycle angle, or over crank angle φ, for operating cycle angle range X that is evaluation-relevant. Resulting integral value I_{KS} proves to be a relevant measured value, derived from the knock sensor signal over operating cycle angle range X. Measured value I_{KS} can be used as a comparison value for comparison with a threshold value SW, wherein threshold value SW is possibly a threshold value SW that is dependent on parameter k and is suitable for detecting whether or not a misfire or, more generally, a combustion misfire has occurred. In a comparison module 53 it is queried within the scope of signal acquisition and/or the evaluation module 50 as to whether the measured value, that is, the integral value over the operating cycle angle range X relating to the knock signal KS over the operating cycle angle φ, is above the relevant threshold value SW or not. The threshold value can be individually adjusted via the parameter k depending on the situation or system, depending on the design of cylinder Z of engine 10.

If query value “Y” is positive, in other words, if integral value I _{KS} is below threshold value SW (k), a misfire can be detected. An indicator module 54 is therefore designed to transmit the detection value “ZA” for a “misfire” ZA to a higher-level control device or to a control device implemented with the signal acquisition and/or evaluation module 50. The control device can, for example, be implemented as the vehicle control 40 on the BUS of the vehicle supporting engine 10.

If, in contrast, the query value from comparison unit 53 is negative “N” in that the integral value I_{KS} is above threshold value SW (k), it can be recognized that there is no misfire. In this case, signal value ‘kZA’ for “no misfire”is transmitted to control device 40.

In the present case of an optional embodiment, the operating cycle angle range is that which follows immediately after the opening of exhaust valve AV. As explained with reference to FIG. 1B, this is the region of exhaust cycle T4 which has a relatively high gradient after the opening of exhaust valve AV; thus, here the operating cycle angle range is at least between 150° and slightly more than 200°, in particular between 140° and 210°. However, if necessary, the operating cycle angle range relevant for the analysis can also be greater and amount to between 90° and 360°. Since the angle range of operating cycle X basically depends on the journal contour of the camshaft, that is, the symbolically drawn camshaft NW1, 11 in FIG. 1A, it is essentially impossible to specify a generally valid value for it. However, it can be seen that this evaluation-relevant operating angle range includes at least 50° after opening of the exhaust valve (taking into account valve clearance) in the cycle of exhaust cycle T4 for an optional operating angle φ of approximately 150°. This represents the decisive valve lift of the exhaust valve AV. A significant opening part of the valve lift at exhaust valve AV is at least 5% of the maximum valve lift in this case. Specifically, a sound measurement signal SM will be acquired from the actual opening of exhaust valve AV for, for example, φ=30°-60° or more, optionally for 50°. The actual opening angle can be determined in FIG. 1B by extrapolating backwards from the tangent to the curve (plotted). In addition, this also depends on the valve clearance.

The underlying value of this distinctive approach to detecting misfires is explained with reference to FIG. 2.

In FIG. 2, the signal of an acceleration sensor, in particular knock sensor 20, that is, knock signal KS, is shown in a voltage unit V.

Voltage unit V more or less directly reflects the measured magnitude of the sound measurement signal by the acceleration sensor, in particular knock sensor 20. FIG. 2 presents knock signal KS as a function of operating cycle angle φ. Specifically, FIG. 2 shows two types of knock signals KS, even though FIG. 2 only shows the basic principle in most cases of operating cycle angle φ due to the overlapping signals.

It is noticeable that in operating cycle angle range X, that is to say between a lower operating cycle angle φ of approximately 150° and an upper operating cycle angle φ of approximately 200° (that is, the above-mentioned exemplary operating cycle angle range X, which is shown in FIG. 1B), a knock signal KS for an operating cycle with combustion (no misfire) in comparison to an operating cycle without combustion (misfire) differs most clearly especially in this operating cycle angle range X.

The reason for this is as follows: when exhaust valve AV opens, the burnt exhaust gas from an operating cycle with regular combustion (that is, an operating cycle with combustion ASmV) exits the combustion chamber significantly louder than from an operating cycle ASoV without combustion, that is, with misfiring. Thus, operating cycles ASmV, as in this example and ASoV, as in this example, in other words, operating cycles with combustion ASmV and operating cycles without combustion ASoV, can be clearly distinguished from one another.

It has been shown that this differential value, that is, its amplitude, is greatest and most pronounced after opening of exhaust valve AV. Integrating over this especially evaluation-relevant operating cycle angle range X most clearly emphasizes the difference between an operating cycle with and without combustion ASmV, ASoV.

For the acceleration sensor, in particular knock sensor 20, a suitable mounting location may be selected on the cylinder head, flame deck, or similarly near exhaust valve AV. For example, a knock sensor 20 can be screwed into cylinder head ZK of cylinder Z of the engine 10. It is also shown that a mounting location on the crankcase of engine 10 is less suitable, since knock sensor 20 is significantly farther away from exhaust valve AV and, therefore, a high-quality measurement recording is not suitable as shown here (with attachment on cylinder head ZK).

In the lower area of FIG. 3B the values are shown—for the integral values I_{KS} explained above with reference to FIG. 4 over operating cycle angle range X—plotted as a value for a plurality of operating cycles (as exemplarily shown in FIG. 2). It can be seen that significant “peaks” (isolated peak values) occur in ranges slightly below 180 operating cycles and slightly above 620 operating cycles. This means that these “peaks” (isolated peak values) characterize particularly small values for a previously mentioned integral over the operating cycle.

A check using the measuring pressure test on the cylinder explained at the beginning shows the same picture, whereby at a measuring pressure close to zero it is clearly evident that ignition has failed or combustion has not occurred; these operating cycles are identified with pASoV in contrast to the operating cycles with combustion, which are all identified with pASmV in the upper part of FIG. 3A.

Moreover, a comparison of FIG. 3A and FIG. 3B shows that the analysis based on knock signal KS in the manner described above is reliable and verifiable.

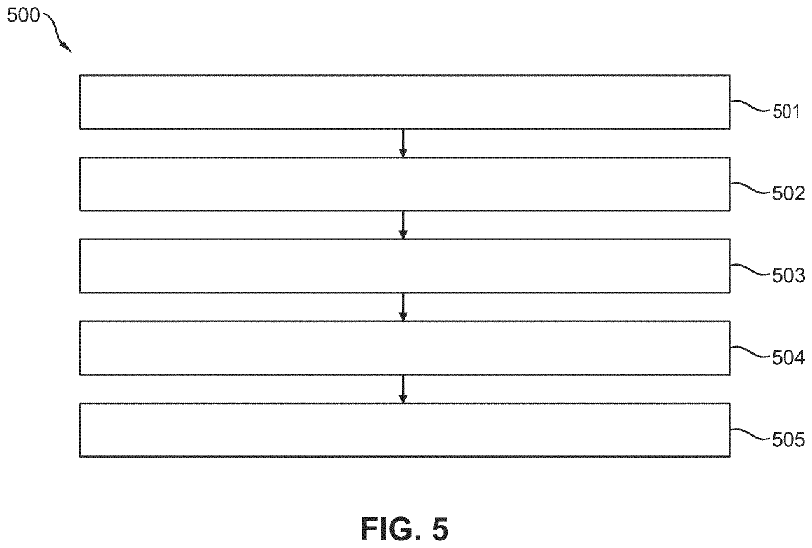

FIG. 5 thus shows an optional and qualified sequence of a method for detecting a misfire in an engine 10. By way of a control device 1, which was explained previously and is shown symbolically in FIG. 4, as part of engine 10, it is possible to carry out the method in conjunction with signal-connected control sensor system 20 and the encoder unit 30.

In a first step of method 500, knock signal KS is detected in step 501 in operating angle range X, which is relevant for evaluation. Evaluation-relevant operating angle range X is, in this respect, generally an angle range parameter whose values can be determined depending on the particular camshaft used.

The herein discussed angle range may vary. With the conventional—as far as can be said—forms of camshafts, an operating angle covers a range from 30° to 70°, optionally 40° to 60°, in particular 45° to 50°, optionally around 50° as in the present case, after opening of exhaust valve AV with a sufficiently large valve lift, which, however, is not too small.

In step 502, knock signal KS can first be fed to a filter, which may, for example, be part of acquisition module 52 of FIG. 4.

As explained with reference to acquisition module 52 by way of FIG. 4, in step 503 the integral is calculated in the manner explained above in the predefined operating cycle angle range X to determine an integral value I_{KS}.

In step 504, a comparison can be performed as explained with reference to comparison module 53 in FIG. 4. The threshold value of the threshold shown can be parameterized in that the measured value is still dependent on the conditions of the specific engine. If, in step 504, the integral is determined to be the relevant value I_{KS}, a comparison with a parameterizable threshold value SWk can be performed in step 504. The result then shows whether the measured integral is above the parameterizable threshold SWk (that is, no misfire, and in module 54 signal value kZA is transmitted from control device 40, for example to the vehicle ECU) or whether integral I_{KS} is below parameterizable threshold SWk (that is, a misfire; that is, in module 54 signal value ZA is transmitted to control device 40, for example to the vehicle ECU).

As a result, a clear distinction can be made between the states “misfire ZA present” and “no misfire kZA present” based solely on the measured signal from the acceleration sensor, in particular knock sensor 20. The concept of the invention is based on the realization that, by opening the exhaust valve AV, gas escaping from the cylinder, that is, in particular, a burned exhaust gas or pressurized (unburned) gas during a combustion cycle ASmV, causes distinct acoustic signals in the form of noise or structure-borne sound signals in the form of pressure or vibration oscillations, particularly in the cylinder head, which are also detected by knock sensor KS.

The background to this is that detection is optimal in a specific working angle range X, which proves to be relevant for evaluation. While opening the exhaust valve with an unburned but compressed air-gas mixture from the cylinder results in significantly less noise than described above, or significantly less structure-borne noise, these two cases can be distinguished immediately after the exhaust valve opens. The difference becomes particularly clear when integrating function KS (φ) over dφ, as explained in evaluation module 52 by way of FIG. 4.

### LIST OF REFERENCE SYMBOLS

1 sensor and evaluation device
10 engine, engine block and control system
11 valve train
12 injector
14 ignition unit
16 intake air duct
17 throttle valve
18 exhaust gas duct
20 knock sensor
30 encoder unit
40 control device, optionally engine control unit (ECU)
50 signal acquisition and/or evaluation module
51 acquisition interface
52 computing module
53 comparison module
54 indicator module
100 internal combustion engine with control environment
500, 501, 502, 503, 504 process step
AS operating cycle
ASmV operating cycle with combustion engine
ASoV operating cycle without combustion engine
DKin throttle valve input signal
DKout throttle valve output signal
GS encoder signal
I_{KS} integral value, detected and/or integrated knock signal KS
IN input
OUT output
pASoV operating cycles w/o combustion based on pressure measurement
pASmV operating cycles with combustion based on pressure measurement
k parameter
K piston
KS knock signal
KW crankshaft
kZA no misfiring
ZA misfiring
NW1, NW2 camshaft
OT top dead center
P connecting rod
SM sound measurement signal
SW threshold value
SW (k) parameterizable threshold value
T1 intake
T2 compression
T3 working
T4 exhaust
V voltage unit
AV exhaust valve
EV intake valve
X, X_{S}, X_{E} operating cycle angle range, start and end of the same
Y query value
Z cylinder
φ crank angle
Z0 tooth
Z1 cylinder sleeve
Z2 cylinder head
ZO pointer
ZK cylinder head
ZR gear

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sensor and evaluation device configured for detecting a misfire in an internal combustion engine, the sensor and evaluation device comprising:
a control sensor system, which includes an acceleration sensor configured for acquiring a sound measurement signal at a cylinder and for providing a knock signal assigned to the sound measurement signal; and
a module configured for at least one of acquiring and evaluating the knock signal,
wherein the sensor and evaluation device is configured such that:
an evaluation-relevant operating cycle angle range is assigned to an operating cycle range after an exhaust valve is opened;
the sound measurement signal at the cylinder is detected by the acceleration sensor at least for the evaluation-relevant operating cycle angle range, and
the knock signal assigned to the sound measurement signal for the evaluation-relevant operating cycle angle range is fed to the module in an evaluable manner.

2. The sensor and evaluation device according to claim 1, wherein the sensor and evaluation device is configured such that the sound measurement signal at the cylinder is assigned entirely or partially to an exhaust cycle as the evaluation-relevant operating cycle angle range.

3. The sensor and evaluation device according to claim 1, wherein the sensor and evaluation device is configured such that the sound measurement signal includes at least one of (a) a structure-borne sound measurement signal at the cylinder and (b) an acoustic sound measurement signal in a surrounding of the cylinder.

4. The sensor and evaluation device according to claim 1, wherein the acceleration sensor is a piezo sensor.

5. The sensor and evaluation device according to claim 4, wherein the piezo sensor is formed as a MEMS (micro-electro-mechanical system) sensor.

6. The sensor and evaluation device according to claim 1, wherein the evaluation-relevant operating cycle angle range is predefined.

7. The sensor and evaluation device according to claim 1, wherein the module is configured for at least one of acquiring and integrating the knock signal via the evaluation-relevant operating cycle angle range.

8. The sensor and evaluation device according to claim 1, wherein the module is configured for comparing the knock signal that is integrated via the evaluation-relevant operating cycle angle range with a threshold value.

9. The sensor and evaluation device according to claim 8, wherein the module is configured to derive a measured value from the detected and/or integrated the knock signal—which is at least one of detected and integrated - via the evaluation-relevant operating cycle angle range, which is relevant for detecting the misfire.

10. The sensor and evaluation device according to claim 9, wherein the module is configured to compare the measured value with the threshold value, wherein the misfire is detected when the measured value is below the threshold value.

11. The sensor and evaluation device according to claim 1, wherein the sensor and evaluation device includes an encoder unit, which includes an encoder gear wheel configured for detecting an operating cycle angle.

12. The sensor and evaluation device according to claim 1, wherein the acceleration sensor is a knock sensor, which is arranged on a cylinder head.

13. The sensor and evaluation device according to claim 1, wherein:
(a) the sensor and evaluation device is configured such that an operating medium in the cylinder is viable for an ignition and a combustion by driving a piston in the cylinder, which is configured for cycling an operating cycle for an intake, a compression, a working, and an expulsion of the operating medium over a piston stroke, wherein the intake is associated with opening of an intake valve and the expulsion is associated with opening of the exhaust valve; and
(b) the acceleration sensor is configured to sensorily detect the sound measurement signal at the cylinder, the sound measurement signal being associated with the expulsion of the operating medium.

14. The sensor and evaluation device according to claim 13, wherein the acceleration sensor, which is a knock sensor, is configured to sensorily detect the sound measurement signal at the cylinder, which is associated with the expulsion of the operating medium, between a start (X_{S}) of the expulsion of the operating medium, after the opening of the exhaust valve, and an end (X_{E}) of the expulsion of the operating medium, before the closing of the exhaust valve.

15. An internal combustion engine, comprising:
at least one of:
(a) a sensor and evaluation device configured for detecting a misfire in the internal combustion engine, the sensor and evaluation device comprising:
a control sensor system, which includes an acceleration sensor configured for acquiring a sound measurement signal at a first cylinder and for providing a knock signal assigned to the sound measurement signal; and
a module configured for at least one of acquiring and evaluating the knock signal,
wherein the sensor and evaluation device is configured such that:
an evaluation-relevant operating cycle angle range is assigned to an operating cycle range after an exhaust valve is opened;
the sound measurement signal at the first cylinder is detected by the acceleration sensor at least for the evaluation-relevant operating cycle angle range, and
the knock signal assigned to the sound measurement signal for the evaluation-relevant operating cycle angle range is fed to the module in an evaluable manner;
(b) a control device;
(c) a control environment, including:
a control device;
a sensor and evaluation device configured for detecting a misfire in the internal combustion engine, the sensor and evaluation device including:
a control sensor system, which includes an acceleration sensor configured for acquiring a sound measurement signal at a first cylinder and for providing a knock signal assigned to the sound measurement signal; and
a module configured for at least one of acquiring and evaluating the knock signal, the control device including the module, the acceleration sensor being signal-connected with the module,
wherein the sensor and evaluation device is configured such that:
an evaluation-relevant operating cycle angle range is assigned to an operating cycle range after an exhaust valve is opened;
the sound measurement signal at the first cylinder is detected by the acceleration sensor at least for the evaluation-relevant operating cycle angle range, and
the knock signal assigned to the sound measurement signal for the evaluation-relevant operating cycle angle range is fed to the module in an evaluable manner;
an encoder unit configured to detect the operating cycle angle, the encoder unit being signal-connected with the module,
wherein:
(i) the internal combustion engine includes a plurality of cylinders including the first cylinder, the first cylinder including an intake valve and the exhaust valve;
(ii) the internal combustion engine is configured such that an operating medium in the first cylinder is viable for an ignition and a combustion by driving a piston in the first cylinder, which is configured for cycling an operating cycle for an intake, a compression, a working, and an expulsion of the operating medium via a piston stroke, wherein the intake is associated with opening of the intake valve and the expulsion is associated with opening of the exhaust valve; and
(iii) the intake valve and the exhaust valve are configured for being operated by way of a valve train via an operating cycle angle of the operating cycle for the operating medium.

16. The internal combustion engine according to claim 15, wherein the internal combustion engine is an Otto engine or a diesel engine, the first cylinder including at least one of an ignition unit and an injection unit.

17. The internal combustion engine according to claim 15, wherein the acceleration sensor is a knock sensor.

18. The internal combustion engine according to claim 15, wherein the encoder unit is configured to detect the operating cycle angle, which is a crank angle of the first cylinder of the internal combustion engine, the encoder unit being a measuring wheel configured for detecting the operating cycle angle of the first cylinder of the internal combustion engine, the measuring wheel being formed as an encoder gear.

19. A method for detecting an ignition misfire in an internal combustion engine, the method comprising the steps of:
providing the internal combustion engine, which includes:
at least one of:
(a) a sensor and evaluation device configured for detecting a misfire in the internal combustion engine, the sensor and evaluation device comprising:
a control sensor system, which includes an acceleration sensor configured for acquiring a sound measurement signal at a first cylinder and for providing a knock signal assigned to the sound measurement signal; and
a module configured for at least one of acquiring and evaluating the knock signal,
wherein the sensor and evaluation device is configured such that:
an evaluation-relevant operating cycle angle range is assigned to an operating cycle range after an exhaust valve is opened;
the sound measurement signal at the first cylinder is detected by the acceleration sensor at least for the evaluation-relevant operating cycle angle range, and
the knock signal assigned to the sound measurement signal for the evaluation-relevant operating cycle angle range is fed to the module in an evaluable manner;
(b) a control device;
(c) a control environment, including:
a control device;
a sensor and evaluation device configured for detecting a misfire in the internal combustion engine, the sensor and evaluation device including:
a control sensor system, which includes an acceleration sensor configured for acquiring a sound measurement signal at a first cylinder and for providing a knock signal assigned to the sound measurement signal; and
a module configured for at least one of acquiring and evaluating the knock signal, the control device including the module, the acceleration sensor being signal-connected with the module,
wherein the sensor and evaluation device is configured such that:
an evaluation-relevant operating cycle angle range is assigned to an operating cycle range after an exhaust valve is opened;
the sound measurement signal at the first cylinder is detected by the acceleration sensor at least for the evaluation-relevant operating cycle angle range, and
the knock signal assigned to the sound measurement signal for the evaluation-relevant operating cycle angle range is fed to the module in an evaluable manner;
an encoder unit configured to detect the operating cycle angle, the encoder unit being signal-connected with the module,
wherein:
(i) the internal combustion engine includes a plurality of cylinders including the first cylinder, the first cylinder including an intake valve and the exhaust valve;
(ii) the internal combustion engine is configured such that an operating medium in the first cylinder is viable for an ignition and a combustion by driving a piston in the first cylinder, which is configured for cycling an operating cycle for an intake, a compression, a working, and an expulsion of the operating medium via a piston stroke, wherein the intake is associated with opening of the intake valve and the expulsion is associated with opening of the exhaust valve;
(iii) the intake valve and the exhaust valve are configured for being operated by way of a valve train via an operating cycle angle of the operating cycle for the operating medium;
(iv) wherein the internal combustion engine includes the control device and the control sensor system, which is signal-connected to the control device;
detecting, using the acceleration sensor of the control sensor system, the sound measurement signal at the first cylinder, the acceleration sensor providing the knock signal that is assigned to the sound measurement signal;
detecting an evaluating, using the module, the knock signal;
assigning the evaluation-relevant operating cycle angle range to the operating cycle range after the exhaust valve is opened;
detecting the sound measurement signal at the first cylinder by a knock sensor at least for the evaluation-relevant operating cycle angle range, the acceleration sensor being the knock sensor; and
evaluating the knock signal assigned to the sound measurement signal for the evaluation-relevant operating cycle angle range, and feeding the knock signal to the module.

20. The method according to claim 19, wherein:
the operating medium in the first cylinder is viable for the ignition and the combustion by driving the piston in the first cylinder, which cycles the operating cycle for the intake, the compression, the working, and the expulsion of the operating medium via the piston stroke;
the intake is associated with opening of the intake valve, and the expulsion is associated with opening of the exhaust valve; and
the acceleration sensor sensorily detects the sound measurement signal at the first cylinder that is associated with the expulsion of the operating medium.
